(19) United States
(12) Patent Application Publication
(10) Pub. No.: US 2005/0163959 A1
(43) Pub. Date: Jul. 28, 2005

(54) Wall covering system and mounting member therefor

(75) Inventors: Michael Cross, Baie D'Urfe (CA); Russell Grant, Montreal (CA)

Correspondence Address: OGILVY RENAULT LLP, 1981 MCGILL COLLEGE AVENUE, SUITE 1600, MONTREAL, QC, H3A2Y3, CA

(73) Assignee: CRANT CORPORATION

(21) Appl. No.: 11/015,332

(22) Filed: Dec. 20, 2004

Related U.S. Application Data
(60) Provisional application No. 60/530,913, filed on Dec. 22, 2003.

(51) Int. Cl. G12B 9/00

(52) U.S. Cl. 428/40.1

(57) ABSTRACT

A mounting member for mounting at least one wall covering member to a wall surface. The mounting member comprises an adherent rear surface removably fastenable to the wall surface and an exposed outer surface which defines at least one wall covering receiving portion for captively receiving the wall covering member. The wall covering receiving portion has a localization aid provided to align the wall covering member in a fixed predetermined position and orientation on the wall covering receiving portion.

### CROSS-REFERENCE TO RELATED APPLICATIONS

This application claims priority under 35USC§119(e) of U.S. provisional patent application 60/530,913 filed on Dec. 22, 2003, the full specification of which is incorporated herein by reference.

### TECHNICAL FIELD

The present invention relates generally to a mounting element or anchor adapted to be removably adhered to a wall for supporting and locating wall coverings, pictures, photographs and the like therefrom.

### BACKGROUND OF THE INVENTION

Hooks which fasten to a wall surface and which provide a mounting point used to suspend a picture or other article therefrom are well known. For example, self-adhesive hooks which permit selective removal from a mounting surface when necessary, are commonly used as general utility hooks from which coats, towels, wall hangings, clocks, picture frames and the like can be suspended. Such adhesively mounted supports are generally designed for suspending any such article from a mounting surface such as a wall using an adhesive material. It is also known to provide a mounting assembly which permits the suspended article to be removed from the mounting surface. This can be done, for example, using removably adhesive strips or removable fasteners.

Mounting supports which split into two portions such that the suspended article can be removed from the wall without interrupting the adhesive bond between either the article and an article engaging portion of the mounting support, or between the wall and the corresponding wall engaging portion of the mounting support, are also well known. Accordingly, the article engaging portion of the mounting support can be selectively engaged and disengaged from the wall engaging portion thereof.

However, known mounting support members, once fastened to the wall, require the user to attach the article to be suspended in a fixed position relative thereto. Particularly, once a hook-type mounting support is in place, the article must be suspended by the protruding hook portion. Thus, such typical known wall mounting supports do not provide any guide means to assist the user in locating the article to be supported from the wall in a desired position thereon.

Further, while wall mounting members are well known for hanging pictures and the like from wall surfaces, such picture hooks or attachment devices do not readily permit a plurality of pictures or wall covering members to be inter-connected and suspended from the wall surface in a desired pattern or alignment.

### SUMMARY OF THE INVENTION

It is an object of the present invention to provide a mounting member which can be removably adhered to a wall and which has an article receiving portion which provides a localisation aid such that the article is mounted on the wall in a desired position and orientation.

It is another object of the present invention to provide an improved wall covering system, and method of installing same, for removably mounting a plurality of wall covering members to a wall using mounting members which are removably fastenable to the wall and which easily locate the wall covering members in place thereon.

Therefore, in accordance with the present invention, there is provided a mounting member for mounting at least one wall covering member to a wall surface, the mounting member comprising an adherent rear surface removably fastenable to said wall surface and an exposed outer surface defining at least one wall covering receiving portion thereon for captively receiving the wall covering member, said wall covering receiving portion having a localization aid provided to align the wall covering member in a fixed predetermined position and orientation on said wall covering receiving portion.

There is also provided, in accordance with the present invention, a mounting member for engaging at least two wall covering members to a wall surface, comprising a base element defining at least first and second mounting portions having fastening means thereon adapted to retain the wall covering members to said mounting member, said first and second mounting portions comprising a localization aid providing relative alignment of the wall covering members in a fixed predetermined position and orientation relative to each other on the wall surface.

There is also provided, in accordance with the present invention, a mounting member for engaging a wall covering to a wall surface, the mounting member comprising a base element having a rear surface removably fastenable to the wall surface and an opposed outer surface from which projects an elevated portion defining at least one wall covering receiving region on said outer surface, said wall covering receiving region having fastening means thereon adapted to fix the wall covering to said base element, said elevated portion providing a localization aid for disposing the wall covering thereon in a desired position and orientation.

There is further provided, in accordance with the present invention, a wall covering system comprising a plurality of wall covering members mountable to a wall surface in a predetermined configuration with respect to one another by a plurality of mounting members, each said mounting member having an adherent rear surface removably fastenable to said wall surface and an exposed outer surface defining at least one wall covering receiving portion thereon for captively receiving the wall covering member, said wall covering receiving portion having a localization aid permitting at least a first one of said wall covering members to be aligned in a fixed predetermined position and orientation on said wall covering receiving portion relative to an adjacent second one of said wall covering members mounted to said wall surface by said mounting members.

There is provided further still, in accordance with the present invention, a method of installing a wall covering assembly comprising: providing a wall covering sheet having at least one dimension defined between opposed first and second edges; engaging said wall covering sheet to at least one mounting member by aligning said first edge with a localization aid defined thereon and fastening said first edge to said at least one mounting member; and removably fastening said at least one mounting member to a wall surface.

### BRIEF DESCRIPTION OF THE DRAWINGS

Further features and advantages of the present invention will become apparent from the following detailed description, taken in combination with the appended drawings, in which:

FIG. 1 is a cross-sectional view of the wall mounting member in accordance with the present invention;

FIG. 2a is a top elevation view of the base disc element of the wall mounting member of FIG. 1;

FIG. 2b is a side elevation view of the base disc member of FIG. 2a;

FIG. 3a is a bottom elevation view of the cover element of the wall mounting member of FIG. 1;

FIG. 3b is a side elevation view of the cover element of FIG. 3a; and

FIG. 4 is a perspective view of a plurality of wall mounting members in accordance with the present invention engaged to a wall surface for affixing a plurality of wall covering members thereto.

### DETAILED DESCRIPTION OF THE PREFERRED EMBODIMENT

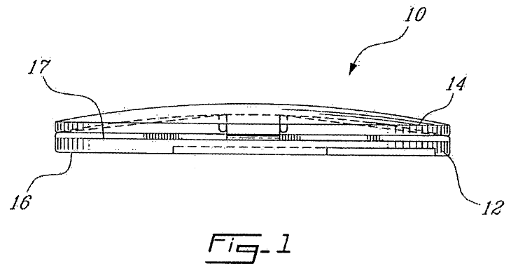

Referring to FIG. 1, the wall mounting member 10 of the present invention comprises generally a disc-shaped base element 12 and a correspondingly cover element 14. The lower surface 16 of the base element 12 is adapted to be adhered to a wall surface, preferably using a removable adhesive or an equivalent removable fastening means. In a preferred embodiment of the present invention, a removable adhesive strip such the Command™ Adhesive strip made by 3M™ is used. While the base element 12 can be permanently fastened to a wall surface, a removable fastening means is preferably used such that the wall mounting member 10 can be selectively engaged to the wall and easily disengaged as desired without causing damage to the wall surface. At least the base element 12 of the mounting member 10 is preferably adapted for suspending substantially flat decorative articles, such as pictures, posters, wall panels and the like, from a wall surface. As will be described further, the mounting members 10 can be removably adhered to a wall surface, and permit the decorative articles to be quickly and easily fixed thereto in a predetermined position and orientation. The mounting members 10 therefore permit a single article to be easily mounted on a wall in a desired position, and further permit a plurality of such articles to be easily aligned relative to one another on the wall surface. As the mounting members of the present invention provide generally speaking links for engaging a plurality of such decorative articles to a wall surface, the present invention has been termed “wALL links”.

The terms “wall” and “wall surface” are used herein to describe the surface to which the mounting member 10 are affixed, as walls remain the most likely surface to which they would be fastened, however these terms as used herein are intended to include all substantially flat surface areas from which a decorative article such as a picture, poster or panel may be engaged, such as a ceiling, wall, door, window and the like.

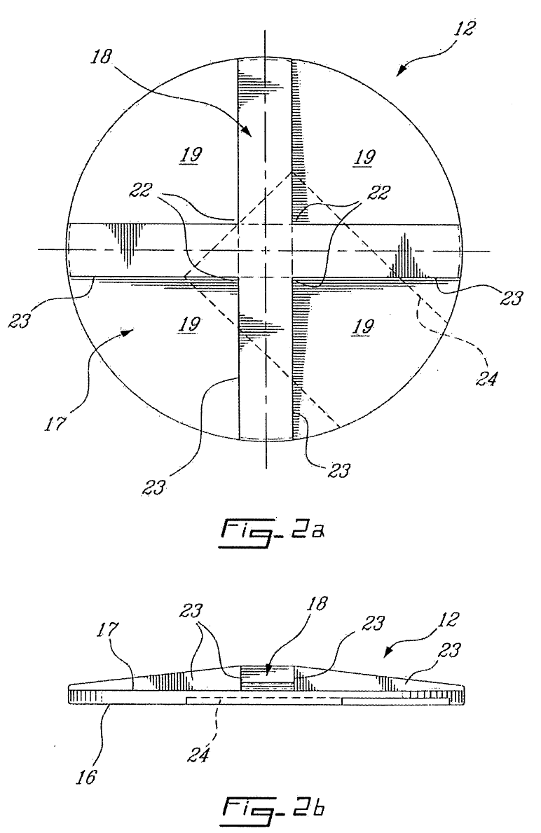

As seen in FIG. 2a, the disc-shaped base element 12 is generally circular and comprises an elevated central cruciform-shaped portion 18 which accordingly divides the upper surface 17 of the base disc into pie-shaped regions 19 on either side of the extending limbs of the elevated cruciform-shaped portion 18. These pie-shaped regions 19 are preferably provided with an adhesive having a peel-away protective sheet overtop thereof. Accordingly, once the article to be suspended from the wall is ready to be attached to the mounting member 10, the protective sheet can be peeled away, such that the article can be placed over pie-shaped regions 19 and adhered thereto.

Accordingly, once the wall mounting member 10 is adhered to the wall surface, engaging a picture or a panel of a wall covering member thereto can be rapidly done. Further, the picture or a wall covering panel is easily aligned using the upstanding guide walls 23 and corners 22 of the cruciform-shaped portion 18 on the base element 12. As best seen in FIG. 2b, the cruciform-shaped portion 18 is elevated, being higher at the center and tapering down toward the upper surface 17 of the base element 12 at the radially outer edges thereof. The upstanding walls 23 of the elevated cruciform portion 18 are preferably used to guide and the edges of the picture or wall covering article being affixed to the base element 12, and help locate the article in a desired location defined by the position and orientation of the mounting member 10.

Although in the preferred embodiment of the present invention the cruciform-shaped portion 18 of the base element 12 is elevated, the pie-shaped regions 19 of the upper surface 17 can be simply visually marked by a localization aid such as a line or other marking means, thereby eliminating the need for the central raised portion 18. In such an alternate embodiment, no central elevated portion exits, and marking means alone are used to guide the user to align the edges of the suspended article relative to the mounting member 10, before the article is engaged thereto, such that the article is located in the desired position and orientation on the wall surface. Further, the mounting member 10 of the present invention can comprise simply an element removably engageable to the wall, the element having a receiving portion thereon to which the article can be fixed and a localization aid which defines the receiving portion such that the user is guided to locate the article on the mounting member in a desired position. The localization aids also preferably permits the user to fix a second article to the element in a predetermined and aligned position relative to another article also engaged to the wall by the same mounting member. Accordingly, such a mounting member of the present invention can comprise simply a removably fastening member, such as for example a hook and loop type attachment element or a two-sided adhesive element, which can be engaged to a wall surface and has marking lines on the outer surface thereof which visually indicate where and in what position thereon to fix two wall covering articles adapted to be suspended from the wall by the mounting member.

Alternately, two cruciform-shaped portions 18 are provided, one on either side of the disc-shaped portion of the base element 12. In yet another alternate embodiment, the base element 12 comprises only a cruciform-shaped portion, dispensing of the circular disc portion of the base element entirely. In such an alternate embodiment, the cruciform-shaped portion can be directly adhered to the wall surface, the limbs of the cruciform portion serve to align the article to be mounted to the wall, and the corners of the article are removably adhered directly to the surface of the wall. Further, although the elevated portion 18 of the base element 12 is cruciform-shaped, alternately shaped raised portions can similarly be used to achieve the same result, by providing guiding edges which divide the upper surface of the mounting member 10 into regions adapted to receive and align the suspended article fixed to the mounting member.

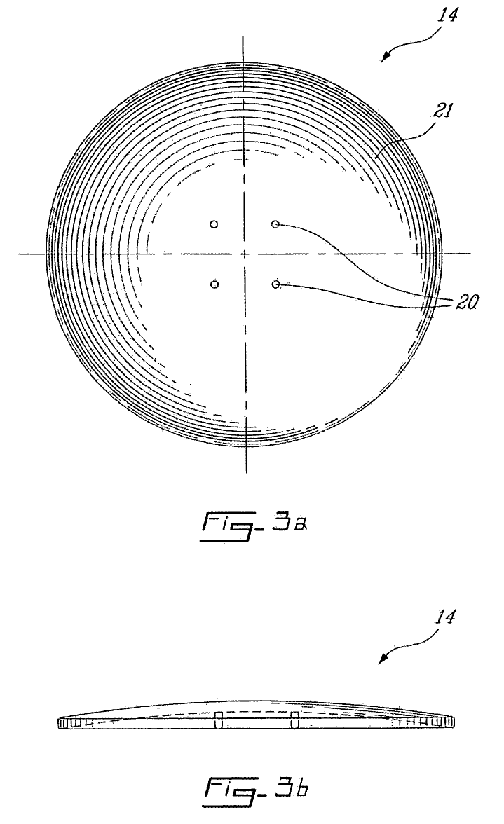

Referring back to FIGS. 3a and 3b, the disc-shaped cover element 14 is engaged to the base element 12 overtop thereof. The cover element 14 can be used simply as a decorative cover plate, which covers the base element 12 and the corners of the wall covering adhered thereto as described above. Alternately, rather than providing adhesive on the pie-shaped regions 19 of the upper surface 17 of the base element 12, the cover element 14 can be used to retain the picture or wall panel in place on the base disc 12. In such an embodiment, the cover element 14 is preferably more securely fastenable to the base element 12 such that the corners of the wall covering article are squeezed between the base element 12 and the cover element 14 sufficiently to retain the wall covering article in place. For example, the cover portion 14 can be hinged to the base element 12 and may be selectively locked in position when closed. Alternately, the cover element 14 and the base element 12 can be engaged by sliding the two portions together, such that the wall covering article is retained therebetween.

When used simply as a decorative cover, as per the depicted preferred embodiment of the present invention, the cover element 14 preferably comprises four pins 20 which are integrally formed with the cover element 14 and which protrude from a lower surface 21 thereof. Each of the pins 20 is positioned so as to abut with one of the corresponding four corners 22, defined by the intersection of the walls 23 of the base element's cruciform-shaped portion 18. The cover element 14 can therefore be positioned over the base element 12 and pressed into engagement therewith, the cover element 14 remaining fixed in place on the base element 12 by a friction fit between the pins 20 and the surfaces of the elevated cruciform-shaped portion 18.

Referring back to FIGS. 2a and 2b, a recessed groove 24 is defined in the rear surface 16 of the base element 12. The groove 24 therefore opens toward the wall surface, such that a removable adhesive strip or other removable fastening means, such as a hook and loop type fastener system for example, can be disposed therein while preferably remaining relatively flush with the rear surface 16 of the base element 12. If the wall mounting member 10 is to be fixed to a metallic surface, a magnet may similarly be used in place of the removable adhesive within the groove 24. Alternately, a hook and loop type attachment device, similarly disposed within the groove 24, may be used to removably fasten the base element 12 to the wall surface.

As few as two wall mounting members 10 can be used to affix a single article such as a picture, poster or thin panel to a wall surface, for example by positioning a mounting member 10 at two corners of the article, or on opposed edges thereof. However, preferably each corner of such an article is fixed to the wall surface by a mounting member 10.

The mounting members 10 have been described generally herein with respect to one embodiment thereof, in which the mounting members are disk-shaped base portions having an adherent rear surface which is removable fastenable to the wall surface and an opposed an substantially parallel outer surface on which the wall covering receiving portions are defined. However, other possible embodiments of the base elements of the mounting members are possible. For example, in an alternate embodiment, the mounting member is itself a cube or rectangular shaped box, either solid or hollow, having a rear surface which is removably adherent to the wall surface and defining slots, openings or recesses in any number of the five other exposed side walls thereof for receipt of the wall covering panels. As each such cube-shaped mounting member projects a greater distance away from the wall surface than the disk-shaped mounting members previously described, each such cube-shaped mounting member may include a plurality of slots at varying distances from the rear adherent surface thereof, such that the wall covering panels mounted to the wall surface can be positioned at any one of several possible corresponding distances away from the wall surface. This provides the possibility of mounting a plurality of wall panels at different set-off distances from the wall surface, such that a three-dimensional effect may be created. In this alternate embodiment, the slots, openings, recesses and the like provided in the cube-shaped mounting members to receive and guide the wall covering panels define the localization aids to align the wall covering panels in fixed predetermined positions and orientations relative to each other.

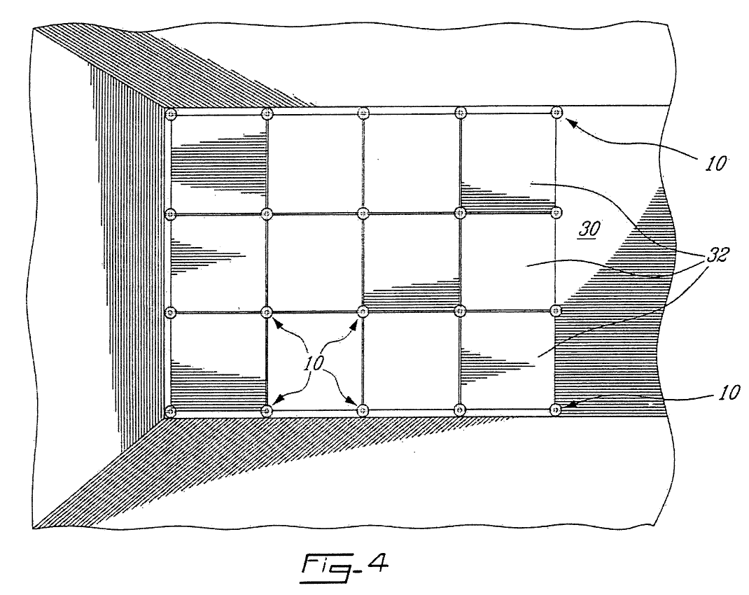

When used as depicted in FIG. 4, a plurality of wall mounting members 10 are removably adhered to a wall surface 30 in a predetermined pattern or alignment. Accordingly, a plurality of wall covering panels 32 may be easily and quickly mounted to the wall surface 30, thereby providing a covering for much of the wall surface. This can be used to quickly change the color, image or texture of the wall. One advantage of such a wall covering system is that little or no wall preparation is required prior to installation of the mounting members 10 to the wall surface 30. When the wall mounting members 10 are fixed to the wall surface 30 using removable adhesive or other similar removably fastening means, such a wall covering system comprising the mounting member 10 and the panels 32 provides a quick, inexpensive and easily installable system for changing the color or look of a complete wall surface. This permits the user to create a significant visual effect by rapidly changing the color or appearance of substantially any surface. The panels 32 can have images or patterns depicted on them, thereby providing a complete composite image made of the plurality of individual panels 32. This can be used, for example, to create an advertisement, a wall display, a mural, a corporate booth display and the like. The panels 32 used can be of any type, however they are preferably formed of a thin, flexible material such as cardboard, plastic or sheet metal, such that they can easily be curved to accommodate differently base shaped wall surfaces or to create three dimension effects on a flat wall surface. For example, such flexible panels can be installed to the wall such that they curve outwards, creating a convexly protruding wall covering. Such an effect could be used, for example, to create the wavy look of a hung curtain on wall using aligned flexible panels located on the wall such that they bow outward. Panels composed of such thin and flexible material can also be readily cut into smaller sized sections as necessary to suit the specific installation requirements. Although the wall panels 32 depicted in FIG. 4 are all similarly shaped, and are more specifically regularly shaped, ie: they are square, it is to be understood that the plurality of panels 32 engaged to the wall surface by the mounting members of the present invention, can comprise several different shapes and sizes. As such, the mounting members used for such applications include localization aids which accommodate the various edges or corners of such irregularly shaped, or variously shaped, wall panels. A possible application of such an application includes the creation of a stained glass window effect a wall surface, using variously shaped wall panels 32 engaged to the wall surface by the mounting members of the present invention. Similarly, transparent or translucent wall panels 32 may be mounted directly overtop of windows to create a temporary stained glass type effect.

One possible method for installing such a wall covering system, includes providing two wall mounting members 10 which are preferably aligned and adhered to the wall surface 30 such that two corners of a first wall covering panel 32 can be engaged to the two wall mounting members 10. Alternately, the two wall mounting members 10 may be first adhered to the first wall covering panel 32, and then adhere to the wall surface 30. This accordingly reduces the necessity for measuring the necessary spacing between the two wall mounting members 10. The position, orientation and alignment of this first panel relative to a reference such as a floor, ceiling, corner, or alignment mark is preferably checked to ensure correct alignment of the wall covering panel. Once this is done, wall mounting members 10 can be affixed to the two remaining corners of the wall covering panel 32, by peeling of the protective covers from the pie-shaped regions 19 of the base element 12, adhering the corners in place on the base element 12 using the alignment means described above, and adhering the base element 12 to the wall surface 30. Once a first wall covering panel 32 is thus installed, further panels can be easily engaged to the wall, by simply adhering their corners in place on the regions 19 of the mounting members 10 making sure to use the edges 23 of the elevated portion 18 or the corresponding visual alignment means to correctly position the latest panel relative to the ones already installed. Such a subsequent wall covering panel 32 is thereby simply aligned using the mounting members 10. Further panels can similarly be rapidly and easily installed to the wall surface to create a complete wall covering, as depicted in FIG. 4.

While FIG. 4 depicts a wall covering system in which each of the wall covering panels 32 are engaged to the wall by four mounting members 10 fastened to the wall surface 30, it is also possible to fasten only the top row of wall covering panels 32 to the wall surface 30. In such a case, the lower panels are interconnected and suspended from the upper panels which are fixed directly to the wall surface. For example, the lower, freely hanging panels may be suspended from the fixed panels by string-like connections, or by more rigid plastic strips which interlock adjacent panels together. Poster framing type plastic strips may be used for this interconnection. Accordingly, such a system could be used both as a wall cover, or as a room divider or curtain, wherein the lower panels are not fixed to any surface, but are freely suspended from an upper, fixed row of panels.

In an alternate embodiment, the mounting members have a base element which comprises a flat base portion having a first side adapted to be removably adhered to the wall surface, and an opposed second side from which project four equally spaced pegs. These pegs provide localization aids for the user such that wall covering panels which are to be suspended form the wall surface by such alternate mounting members can be correctly positioned and aligned relative to one another. The pegs mate with holes defined in the wall covering panels, such that the wall covering panels are fixed in place on the mounting members.

The embodiments of the invention described above are intended to be exemplary. Those skilled in the art will therefore appreciate that the forgoing description is illustrative only, and that various alternatives and modifications can be devised without departing from the spirit of the present invention. For example, although the mounting member of the present invention has been depicted as having a disc-shaped top elevation, mounting members having alternate shapes could be similarly be used, such those being rectangular, square or triangular, and those representing objects such as animals, cars, etc. Accordingly, the present is intended to embrace all such alternatives, modifications and variances which fall within the scope of the appended claims.

1. A mounting member for mounting at least one wall covering member to a wall surface, the mounting member comprising an adherent rear surface removably fastenable to said wall surface and an exposed outer surface defining at least one wall covering receiving portion thereon for captively receiving the wall covering member, said wall covering receiving portion having a localization aid provided to align the wall covering member in a fixed predetermined position and orientation on said wall covering receiving portion.

2. The mounting member as defined in claim 1, wherein said localization aid defines at least two mounting zones on said wall covering receiving portion, said localization aid permitting at least a second wall covering member to be engaged to said mounting member in a predetermined position and orientation relative to the wall covering member.

3. The mounting member as defined in claim 1, wherein said localization aid protrudes from the wall covering receiving portion and defines guide surfaces thereon for guiding and aligning an edge of the wall covering member when abutted thereagainst.

4. The mounting member as defined in claim 3, wherein the localization aid defines four distinct mounting zones on said wall covering receiving portion, each of the four distinct mounting zones being configured to receive thereon a corner of one of said wall covering members.

5. The mounting member as defined in claim 4, wherein said localization aid comprises a cruciform portion, said four distinct mounting zones being defined intermediately between adjacent limbs of said cruciform portion.

6. The mounting member as defined in claim 1, wherein said wall covering receiving portion has a means for fastening said wall covering member in place thereon.

7. The mounting member as defined in claim 6, wherein said means for fastening is an adhesive which removably adheres said wall covering member to said mounting member.

8. The mounting member as defined in claim 1, wherein said adherent rear surface of the mounting member is releasable from the wall surface.

9. The mounting member as defined in claim 1, wherein a cover element is removably engageable to said mounting member, said cover element covering at least said wall covering receiving portion.

10. A mounting member for engaging at least two wall covering members to a wall surface, comprising a base element defining at least first and second mounting portions having fastening means thereon adapted to retain the wall covering members to said mounting member, said first and second mounting portions comprising a localization aid providing relative alignment of the wall covering members in a fixed predetermined position and orientation relative to each other on the wall surface.

11. A wall covering system comprising a plurality of wall covering members mountable to a wall surface in a predetermined configuration with respect to one another by a plurality of mounting members, each said mounting member having an adherent rear surface removably fastenable to said wall surface and an exposed outer surface defining at least one wall covering receiving portion thereon for captively receiving the wall covering member, said wall covering receiving portion having a localization aid permitting at least a first one of said wall covering members to be aligned in a fixed predetermined position and orientation on said wall covering receiving portion relative to an adjacent second one of said wall covering members mounted to said wall surface by said mounting members.

12. The wall covering system as defined in claim 11, wherein said wall covering members comprise wall panels.

13. The wall covering system as defined in claim 12, wherein said wall panels have a coloured outer surface, said wall panels providing a colour change to said wall surface.

14. The wall covering system as defined in claim 12, wherein at least one of said wall panels includes at least one of an image, a texture and a pattern thereon.

15. The wall covering system as defined in claim 12, wherein said wall panels are at least partially flexible.

16. The wall covering system as defined in claim 15, wherein said wall panels are flexible into a curved position relative to said wall surface.

17. The wall covering system as defined in claim 11, wherein said localization aid defines at least two mounting zones on said wall covering receiving portion.

18. The wall covering system as defined in claim 11, wherein said localization aid protrudes from the wall covering receiving portion and defines guide surfaces thereon for guiding and aligning edges of the wall covering members when abutted thereagainst.

19. The wall covering system as defined in claim 18, wherein said localization aid comprises a cruciform portion defining four distinct mounting zones on said wall covering receiving portion, each of said four distinct mounting zones being disposed intermediately between adjacent limbs of said cruciform portion and receiving a corner of one of said wall covering members.

20. The wall covering system as defined in claim 11, wherein said wall covering receiving portion has an adhesive thereon which removably adheres said wall covering members thereto.

21. The wall covering system as defined in claim 11, wherein said adherent rear surface of the mounting member is releasable from the wall surface without causing significant damage thereto.

22. The wall covering system as defined in claim 11, wherein a cover element is removably engageable to said mounting member, said cover element covering at least said wall covering receiving portion thereof.
